(19) United States
(12) Patent Application Publication
(10) Pub. No.: US 2015/0008683 A1
(43) Pub. Date: Jan. 8, 2015

(54) ELECTROMAGNETIC DOOR LOCK PARTICULARLY FOR DOORS IN ESCAPE ROUTES

(71) Applicants: Kai Gröne, Witten (DE); Matthias Drux, Gevelsberg (DE)

(72) Inventors: Kai Gröne, Witten (DE); Matthias Drux, Gevelsberg (DE)

(21) Appl. No.: 14/319,782

(22) Filed: Jun. 30, 2014

(30) Foreign Application Priority Data
Jul. 3, 2013 (DE) DE 102013011163.3

(51) Int. Cl. E05C 17/56

(52) U.S. Cl. CPC E05C 17/56
USPC 292/251.5

(57) ABSTRACT

An electromagnetic door lock has an electromagnet which cooperates with an armature plate. The armature plate has an adjusting unit fastened to the armature plate so as to be freely rotatable and which cooperates with a threaded rod that is secured to the door or to the door frame.

### BACKGROUND OF THE INVENTION

1. Field of the Invention

The present invention is directed to an electromagnetic door lock, particularly for doors in escape routes, having an electromagnet which cooperates with an armature plate.

2. Description of the Related Art

In a known electromagnetic door lock, the armature plate is fixedly screwed to a lintel or door by a countersunk screw and a rubber buffer. In so doing, the position of the armature plate can be influenced only to a very slight extent by the tightening torque of the countersunk screw.

### SUMMARY OF THE INVENTION

Therefore, it is an object of the present invention to provide a door lock of the type mentioned above that makes it simpler to adjust and align the armature plate with respect to the door.

In an electromagnetic door lock, particularly for doors in escape routes, having an electromagnet cooperating with an armature plate, the above-stated object is met according to the invention in that the armature plate is provided with an adjusting unit fastened to the armature plate so as to be freely rotatable and which cooperates with a threaded rod that is secured to the door or to the door frame.

As a result of the construction according to the invention, the armature plate can be easily and simply aligned.

According to an advantageous further development, the adjusting unit has an internally threaded sleeve with a radially projecting collar.

The collar advantageously passes into the internally threaded sleeve by a conical portion.

According to a preferred embodiment, the internally threaded sleeve is screwed onto an external thread of the threaded rod.

To screw the threaded sleeve into a screw sleeve arranged at the door or at the frame of the door, the threaded rod according to an advantageous embodiment has at its front side projecting into the threaded sleeve a recess, inter alia, for the engagement of a tool.

The collar is advantageously provided with an axial through-opening that allows access to the recess in the threaded sleeve.

According to a preferred further development, the collar has, on its side remote from the internally threaded sleeve, at least one engagement opening for the engagement of a special purpose tool by which the adjusting unit can be aligned with respect to the threaded rod. A special purpose tool is used so that an unauthorized person is not able to change the position of the armature plate.

According to a preferred construction, the adjusting unit is provided with a cover on the side remote from the threaded rod to cover the adjusting unit from the outer side and to prevent residual magnetization.

According to an advantageous further development, the threaded sleeve is provided with a retaining element on the side remote from the collar in order to fasten the armature plate to the adjusting unit. Accordingly, the armature plate is fixed so as to be freely rotatable between the collar and the retaining element.

In order to improve the free rotation between the armature plate and adjusting unit, the retaining element can advantageously be supported at the armature plate via an elastic buffer. The elastic buffer simultaneously provides for angular compensation. The elastic buffer can be made of Vulkollan, rubber, or the like, for example.

Further, according to a preferred further development, a washer can be arranged between the retaining element and the elastic buffer. Alternatively, the elastic buffer and the washer can also be formed as a one-piece rubber-metal element.

The retaining element can be formed as a nut, preferably as a hexagon nut, which can be screwed onto an external thread of the hexagon socket sleeve.

Alternatively, the retaining element can also be formed as a corrugated retaining ring, which can be snapped into a circumferential groove of the internally threaded sleeve.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further details, features and advantages of the invention are given in the following description referring to the drawings. In the drawings:

FIG. 1 shows a first embodiment of an electromagnetic door lock according to the invention; and

FIG. 2 shows a second embodiment of an electromagnetic door lock according to the invention.

### DETAILED DESCRIPTION OF THE PRESENTLY PREFERRED EMBODIMENTS

The drawings show only the armature plate associated with an electromagnetic door lock and the bearing of the armature plate.

The electromagnetic door lock cooperates with an armature plate 1, which can be arranged at a door or at the frame thereof to ensure a locking of the door in cooperation with an electromagnet.

The armature plate 1 is provided with a through-hole 2 having a first portion 2a and a second portion 2b. The first portion 2a, which has a greater diameter than the second portion 2b, passes into the second portion 2b via a conical flank 2c.

An adjusting unit, which is fixed to the armature plate 1 but can rotate freely with respect to the armature plate 1, is inserted into the through-hole 2.

The adjusting unit has a collar 3, which passes via a conical area into an internally threaded sleeve 4 of smaller diameter.

When inserted into the armature plate 1, the collar 3 lies in the first portion 2a and the internally threaded sleeve 4 lies in the second portion 2b, while the conical area contacts the conical flank 2c of the through-hole 2.

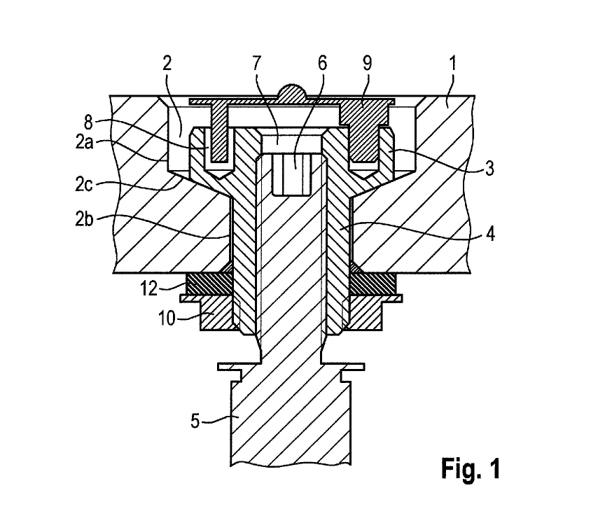

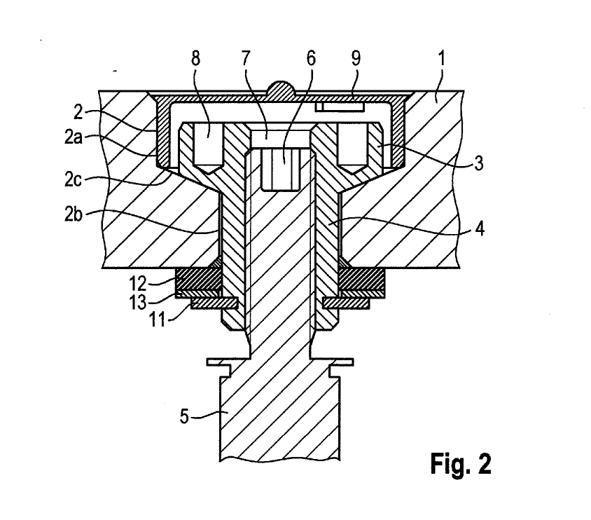

A threaded rod 5, which is shown only partially in FIGS. 1 and 2 and which serves to fasten the armature plate 1 to a door or a door frame, is screwed into the internally threaded sleeve 4.

The threaded rod 5 is provided with a front recess 6 at its portion that is screwed into the internally threaded sleeve 4. A tool for fastening the threaded rod 5 to the door or to the door frame can engage in this front recess 6. For example, the recess 6 can be formed as a hexagon socket in which a suitable tool, e.g., a socket wrench, can be inserted.

To ensure unimpeded access to the recess 6 in the threaded rod 5, the collar 3 is provided with a through-opening 7.

Further, the collar 3 has, on its side remote from the internally threaded sleeve 4, an engagement opening 8 for receiving a cover 9 and for the engagement of a special purpose tool by which the adjusting unit can be aligned with respect to the threaded rod 5.

There can be provided, for example, two engagement openings 8, preferably with different diameters, in which a special purpose tool outfitted with two corresponding pins can be inserted. The use of a special purpose tool of this kind prevents unauthorized persons from adjusting the armature plate 1.

The adjusting unit, particularly the collar 3 thereof having through-opening 7 and engagement openings 8, is covered on the side remote of the threaded rod 5 by a cover 9 which serves to prevent residual magnetization between the armature plate 1 and an electromagnet cooperating with the armature plate 1. The cover 9 is provided with a spherical head 14 preferably made of plastic and which serves to separate the components against adhesive force when no magnetic force is operative.

The internally threaded sleeve 4 is provided on the side remote from the collar 3 with a retaining element 10, 11 supported at the armature plate 1 via an elastic buffer 12 made of Vulkollan, rubber, or the like, for example. A washer 13 (FIG. 2) may possibly be provided between the retaining element 10, 11 and the elastic buffer 12. The buffer 12 serves to compensate for transverse forces exerted through the door and for angular compensation.

Accordingly, as a result of the construction described above, the armature plate 1 is held in a freely rotatable manner between the collar 3 and the elastic buffer 12.

The arrangement described above is identical in both of the embodiment forms shown in FIGS. 1 and 2. The sole difference consists in the arrangement of the retaining element and the fastening of cover 9.

According to FIG. 1, the retaining element comprises a nut 10 screwed onto the external thread of the internally threaded sleeve 4. The nut 10 may be a hexagon nut provided with a flange, for example. An improved support of the elastic buffer 12 is achieved by the flange.

According to FIG. 2, the retaining element comprises a corrugated retaining ring 13 inserted into a circumferential groove of the internally threaded sleeve 4.

Beyond this, as is shown in FIG. 1, the cover 9 is received in at least one engagement opening 8 of the collar 3, while it is inserted into the armature plate 1 according to FIG. 2.

Owing to the arrangement described above, the armature plate 1 can be positioned with respect to the door or the door frame by rotating the adjusting unit comprising the collar 3, the internally threaded sleeve 4, the buffer 12, possibly the washer 13, and the retaining element 10, 11 with a special purpose tool in a certain range, for example, +/−2 mm.

Owing to the arrangement according to the invention, the electromagnetic door lock has two types of tolerance compensation: an “automatic tolerance compensation” by the buffer 12 which counteracts a warping or a setting of the door; and a tolerance compensation by the adjustment of the threaded rod 5, which serves for adjusting during assembly.

The foregoing description of the present invention only serves for purposes of illustration and not for the purpose of limiting the invention. Various changes and modifications are possible within the framework of the invention without departing from the scope of the invention and equivalents thereof.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An electromagnetic door lock, comprising:
an armature plate (1) having an adjusting unit fastened to the armature plate (1) so as to be freely rotatable and which cooperates with a threaded rod (5) that is secured to the door or to a door frame; and
an electromagnet which cooperates with the armature plate.

2. The electromagnetic door lock according to claim 1, wherein the adjusting unit has an internally threaded sleeve (4) with a radially projecting collar (3).

3. The electromagnetic door lock according to claim 2, wherein the collar (3) passes into the internally threaded sleeve (4) by a conical portion.

4. The electromagnetic door lock according to claim 2, wherein the internally threaded sleeve (4) is configured to be screwed onto an external thread of the threaded rod (5).

5. The electromagnetic door lock according to claim 2, wherein the threaded rod (5) has, at its front side projecting into the internally threaded sleeve (4), a recess (6) configured to engage a tool.

6. The electromagnetic door lock according to claim 5, wherein the collar (3) has an axial through-opening (7) configured to allow access to the recess (6) in the internally threaded sleeve (4).

7. The electromagnetic door lock according to claim 6, wherein the collar (3) has on its side remote from the internally threaded sleeve (4) at least one engagement opening (8) configured to engage a special purpose tool by which the adjusting unit can be aligned with respect to the threaded rod (5).

8. The electromagnetic door lock according to claim 1, wherein the adjusting unit has a cover (9) on a side remote of the threaded rod (5).

9. The electromagnetic door lock according to claim 2, wherein the internally threaded sleeve (4) has a retaining element (10, 11) on a side remote from the collar (3).

10. The electromagnetic door lock according to claim 9, wherein the retaining element (10, 11) is supported at the armature plate (1) via an elastic buffer (12).

11. The electromagnetic door lock according to claim 10, further comprising a washer (13) arranged between the retaining element (10, 11) and the elastic buffer (12).

12. The electromagnetic door lock according to claim 11, wherein the internally threaded sleeve (4) is a hexagon socket sleeve and the retaining element is a nut (10) configured to screw onto an external thread of the hexagon socket sleeve (4).

13. The electromagnetic door lock according to claim 9, wherein the retaining element is a corrugated retaining ring (13) configured to snap into a circumferential groove of the internally threaded sleeve (4).

14. The electromagnetic door lock according to claim 13, wherein the nut (10) is a hexagon nut.

15. The electromagnetic door lock according to claim 1, wherein the electromagnetic door lock is adapted for doors in escape routes.
